(19) United States
(12) Patent Application Publication
(10) Pub. No.: US 2024/0232587 A1
(43) Pub. Date: Jul. 11, 2024

(54) METHOD AND ELECTRONIC DEVICE FOR NEURO-SYMBOLIC LEARNING OF ARTIFICIAL INTELLIGENCE MODEL

(71) Applicant: Samsung Electronics Co., Ltd., Suwon-si (KR)

(72) Inventors: Srinivas Soumitri MIRIYALA, Bengaluru (IN); Efthymia TSAMOURA, Bengaluru (IN); Shah Ayub QUADRI, Bengaluru (IN); Vikram Nelvoy RAJENDIRAN, Bengaluru (IN); Venkappa MALA, Bengaluru (IN)

(21) Appl. No.: 18/429,690

(22) Filed: Feb. 1, 2024

Related U.S. Application Data
(63) Continuation of application No. PCT/KR2023/020889, filed on Dec. 18, 2023.

(30) Foreign Application Priority Data
Dec. 19, 2022 (IN) 202241073661
Oct. 30, 2023 (IN) 2022 41073661

(51) Int. Cl. G06N 3/047; G06N 7/01

(52) U.S. Cl. CPC G06N 3/047; G06N 7/01

(57) ABSTRACT

A method and an electronic device for neuro-symbolic learning of an artificial intelligence (AI) model are provided. The method includes receiving input data including various contents and determining in an output of the AI model a predicted probability for each of the contents of the input data, determining a neural loss of the AI model by comparing the predicted probability with a predefined desired probability, determining a symbolic loss for the AI model by comparing the predicted probability with a pre-determined undesired probability, determining weights of a plurality of layers of the AI model, and updating the weights of the plurality of layers of the AI model based on the neural loss and the symbolic loss.

### CROSS-REFERENCE TO RELATED APPLICATION(S)

This application is a continuation application, claiming priority under § 365(c), of an International application No. PCT/KR2023/020889, filed on Dec. 18, 2023, which is based on and claims the benefit of an Indian Provisional patent application number 202241073661, filed on Dec. 19, 2022, in the Indian Intellectual Property Office, and of an Indian Complete patent application number 202241073661, filed on Oct. 30, 2023, in the Indian Intellectual Property Office, the disclosure of each of which is incorporated by reference herein in its entirety.

### BACKGROUND

### 1. Field

The disclosure relates to artificial intelligence (AI). More particularly, the disclosure relates to neuro-symbolic learning or training of an AI model, along with its facilitation for deployment on embedded devices.

### 2. Description of Related Art

AI models have a profound impact on various aspects of our lives, heralding a new era of innovation. These models are being leveraged across a wide range of applications, and their optimization for edge computing as well as their deployment on embedded devices has been instrumental in driving their relentless growth and success.

Despite significant advances in AI technology, conventional neural networks or systems are still unable to comprehend visual concepts. For instance, as depicted in FIG. 1A, conventional neural AI systems tend to label an object as a tree even when it is in motion from one place to another. This is primarily because such systems are unable to fully grasp the contextual information from the surrounding scene, as portrayed in the image or video.

Moreover, the customary neural AI systems exhibit shortcomings in comprehending linguistic concepts inherent in natural language. This is exemplified in FIGS. 1C and 1D, where the conventional neural AI system failed to differentiate between “standing next to” and “chasing by” an animal. This inadequacy arises from the conventional neural AI systems' inability to comprehend the nuances of linguistic concepts.

Thus, it is desirable to furnish a mechanism for AI models that is free from the aforementioned concerns.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide neuro-symbolic learning or training of an AI model, along with its facilitation for deployment on embedded devices.

Another aspect of the disclosure is to determine a neural loss of the AI model through a comparison of a predicted probability with a predefined desired probability for the input data content.

Another aspect of the disclosure is to determine a symbolic loss for the AI model through a comparison of a predicted probability with a pre-determined undesired probability for the input data content.

Another aspect of the disclosure is to determine weights of a plurality of layers of the AI model and updating weights of layers of the AI model based on the neural loss and the symbolic loss.

Additional aspects will be set forth in part in the description which follows and, in part, will be apparent from the description, or may be learned by practice of the presented embodiments.

In accordance with an aspect of the disclosure, a method for neuro-symbolic learning of an artificial intelligence (AI) model is provided. The method includes receiving, by an electronic device, input data comprising a plurality of contents for the neuro-symbolic learning of the AI model, determining a predicted probability for each of the plurality of contents of the input data in an output of the AI model, determining a neural loss of the AI model by comparing the predicted probability for each of the plurality of contents with a predefined desired probability for each of the plurality of contents, determining a symbolic loss for the AI model by comparing the predicted probability for each of the plurality of contents with a pre-determined undesired probability for each of the plurality of contents, determining weights of a plurality of layers of the AI model, and updating the weights of the plurality of layers of the AI model based on the neural loss and the symbolic loss.

In an embodiment, the method includes determining a training loss of the AI model as a measure of the neural loss and the symbolic loss, and updating the weights of the plurality of layers of the AI model in proportion to the determined training loss.

In an embodiment, the method includes selecting an external symbolic knowledge graph comprising a plurality of common-sense facts, constructing a negative knowledge graph comprising a plurality of violating common-sense facts from the external symbolic knowledge graph, identifying a set of maximally violating facts from the plurality of violating common-sense facts, and generating symbolic labels in form of probabilities for the maximally violating facts. The maximally violating facts comprises the undesired probability.

In an embodiment, the plurality of common-sense facts is at least one of a set of pre-defined rules and common-sense facts associated with a real-world.

In an embodiment, the maximally violating facts comprise facts which are against the plurality of common-sense facts with respect to the input data.

In an embodiment, the method includes determining a plurality of contents and relationships between the plurality of contents, and determining at least one scene graph based on the plurality of contents and the relationships between the plurality of contents. The at least one scene graph is a structural representation of the plurality of contents and the relationships between the plurality of contents in the input data.

In an embodiment, the plurality of contents is determined using a neural AI and the relationships between the plurality of contents is determined using a Symbolic AI, adhering to common-sense of a real world through an external symbolic knowledge graph.

In accordance with another aspect of the disclosure, an electronic device for neuro-symbolic learning of an artificial intelligence (AI) model is provided. The electronic device includes a processor, a communicator, a neuro-symbolic AI controller, and memory storing one or more programs including computer-executable instructions that, when executed by the processor, cause the electronic device to receive input data comprising a plurality of contents for the neuro-symbolic learning of the AI model, determine a predicted probability for each of the plurality of contents of the input data in an output of the AI model, determine a neural loss of the AI model by comparing the predicted probability for each of the plurality of contents with a predefined desired probability for each of the contents, determine a symbolic loss for the AI model by comparing the predicted probability for each of the plurality of contents with a pre-determined undesired probability for each of the contents, determine a training loss of the AI model as a measure of the neural loss and the symbolic loss, determine weights of a plurality of layers of the AI model, and update the weights of the plurality of layers of the AI model based on the neural loss and the symbolic loss.

In accordance with another aspect of the disclosure, one or more non-transitory computer-readable storage media storing one or more computer programs including computer-executable instructions that, when executed by one or more processors of an electronic device, cause the electronic device to perform operations are provided. The operations include receiving input data comprising a plurality of contents for neuro-symbolic learning of an artificial intelligence (AI) model, determining a predicted probability for each of the contents of the input data in an output of the AI model, determining a neural loss of the AI model by comparing the predicted probability for each of the contents with a predefined desired probability for each of the contents, determining a symbolic loss for the AI model by comparing the predicted probability for each of the contents with a pre-determined undesired probability for each of the contents, determining weights of a plurality of layers of the AI model, and updating the weights of the plurality of layers of the AI model based on the neural loss and the symbolic loss.

Other aspects, advantages, and salient features of the disclosure will become apparent to those skilled in the art from the following description, which, taken in conjunction with the annexed drawings, discloses various embodiments of the disclosure.

### BRIEF DESCRIPTION OF THE DRAWINGS

The above and other aspects, features, and advantages of certain embodiment of the disclosure will be more apparent from the following description taken in conjunction with the accompanying drawings, in which:

FIG. 1A is an example illustrating classification of objects, according to the related art;

FIG. 1B is schematic diagram illustrating a knowledge graph, according to the related art;

FIGS. 1C and 1D are examples illustrating linguistic concepts, according to the related art;

FIG. 2 is a schematic diagram that elucidates the contrast between conventional systems, according to the related art;

FIG. 3 is a block diagram of an electronic device for training of an AI model, according to an embodiment of the disclosure;

FIG. 4 is a flowchart illustrating a method for training of an AI model, according to an embodiment of the disclosure;

FIG. 5 is an example illustrating a scene graph generation for understanding visual concepts, according to an embodiment of the disclosure;

FIG. 6 is an example illustrating a scene graph generation through a neuro-symbolic AI controller, according to an embodiment of the disclosure;

FIG. 7 is a flowchart illustrating a method for providing neuro-symbolic training of an AI on an edge device, according to an embodiment of the disclosure;

FIG. 8 is a schematic diagram illustrates converting symbolic AI into labels, according to an embodiment of the disclosure;

FIG. 9 is a schematic diagram illustrates obtainment of undesired label, according to an embodiment of the disclosure;

FIG. 10 is a schematic diagram illustrating training pipeline of the neuro-symbolic AI controller, according to an embodiment of the disclosure; and

FIG. 11 is a flowchart illustrating deployment pipeline, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Throughout the disclosure the term “neural loss” refers to a value of any general standard loss metric obtained by comparing the outputs (predictions) of the neural network with the desired outputs or ground truth provided as part of the dataset for training.

Throughout the disclosure the term “symbolic loss” refers to a value of any general standard loss metric obtained by comparing the outputs (predictions) of the neural network with the undesired outputs or symbolic labels that are obtained from external knowledge graphs using neural guided projection.

Throughout the disclosure the term “training loss” refers to aggregation of the neural loss and symbolic loss. A general aggregation rule could be adding both neural and symbolic loss but it need not be specific to such the addition. It could be any possible form of aggregation.

Accordingly, embodiments herein disclose a method for neuro-symbolic learning or training an AI model and enabling deployment of the AI model on embedded device. The method includes receiving, by the electronic device, input data including various contents for training the AI model. Further, the method includes determining, by the electronic device, a predicted probability for each of the contents of the input data in an output of the AI model. Further, the method includes determining, by the electronic device, a neural loss of the AI model by comparing the predicted probability for each of the contents with a predefined desired probability for each of the contents. Further, the method includes determining, by the electronic device, a symbolic loss for the AI model by comparing the predicted probability for each of the contents with a pre-determined undesired probability for each of the contents. Further, the method includes determining, by the electronic device, a training loss of the AI model as a measure of the neural loss and the symbolic loss. Further, the method includes determining, by the electronic device, weights of one or more layers of the AI model. Further, the method includes updating, by the electronic device, the weights of the one or more layers of the AI model in proportion to the determined training loss.

Accordingly, embodiments herein disclose the electronic device for training an AI model. The electronic device includes a memory, a processor coupled to the memory, a communicator coupled to the memory and the processor. The electronic device includes a neuro-symbolic AI controller coupled to the memory, the processor and the communicator. The neuro-symbolic AI controller is equipped to receive the input data including various contents for neuro-symbolic learning or training the AI model. Further, the neuro-symbolic AI controller determines the predicted probability for each of the contents of the input data in the output of the AI model. Further, the neuro-symbolic AI controller determines the neural loss of the AI model by comparing the predicted probability for each of the contents with the predefined desired probability for each of the contents. Further, the neuro-symbolic AI controller determines the symbolic loss for the AI model by comparing the predicted probability for each of the contents with the pre-determined undesired probability for each of the contents. Further, the neuro-symbolic AI controller determines the training loss of the AI model as measure of the neural loss and the symbolic loss. Furthermore, the neuro-symbolic AI controller determines weights of the one or more layers of the AI model and update the weights of the layer(s) of the AI model in proportion to the determined training loss.

The conventional techniques and systems employed for training Neural Networks lack the provision for enabling AI Model training. Additionally, such conventional approaches do not address the issue of implementing neurosymbolic artificial intelligence (NSAI) models on devices with limited resources.

Conventional approaches and systems are inadequate for on-device learning as they lack the ability to comprehend techniques and apprehend visual and linguistic contexts.

In contrast to traditional techniques and systems, the proposed disclosure incorporates Symbolic AI methodology into the training process.

The proposed disclosure diverges from conventional methods and systems by constructing neuro-symbolic AI models that necessitate the utilization of Symbolic knowledge graphs for training. The proposed disclosure offers a highly effective on-device learning strategy.

In contrast to traditional methods and systems, the proposed disclosure enables the creation of NSAI models that do not require symbolic knowledge graphs for inference, thereby facilitating their deployment on embedded devices. The proposed method integrates a common-sense knowledge base to enhance the precision and efficacy of neural AI.

Diverging from traditional methods and systems, the proposed disclosure facilitates proficient on-device learning through the utilization of neuro-symbolic techniques. Notably, the method employs a neuro-symbolic approach to construct scene graphs, thereby enabling improved comprehension of input images.

In contrast to traditional methods and systems, the proposed disclosure incorporates training data as well as a symbolic knowledge base to train a neuro-symbolic approach. Additionally, the proposed method constructs scene graphs as a structural representation of the input data, setting it apart from conventional methods and systems. Further distinguishing itself, the proposed method achieves accuracy comparable to conventional systems while requiring less data. This reduction in necessary data is particularly significant for on-device learning and user personalization, where user-generated data is often limited in quantity.

In traditional approaches, neural AI models are required to learn both connectionist and symbolic tasks, resulting in a larger and more complex model. However, our proposed method diverges from convention by enabling symbolic task learning through External Knowledge graphs. Consequently, the proposed disclosure effectively reduces AI model complexity, resulting in lower power and memory consumption, enhanced latency, and an improved user experience.

In contrast to conventional techniques and systems, the proposed methodology involves training with external knowledge graphs. Additionally, it falls within the realm of explainable AI, offering a fresh perspective for building and deploying NSAI models on embedded devices. Furthermore, the proposed approach allows for convenient deployment and inference of a neuro-symbolic AI model on resource-constrained edge and embedded devices, such as smartphones. The method enables the construction of simpler neural AI models that are regulated with symbolic knowledge, therefore yielding explainable results. Moreover, the technique enables AI model construction in data-scarce environments, facilitating efficient personalization. By incorporating symbolic knowledge to design explainable, accurate, lightweight, and user-personalized neuro-symbolic AI for edge devices, the proposed approach distinguishes itself from traditional approaches. Finally, it permits efficient personalization and on-device learning in data-scarce settings.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU), a communication processor (CP, e.g., a modem), a graphical processing unit (GPU), a neural processing unit (NPU) (e.g., an artificial intelligence (AI) chip), a wireless fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

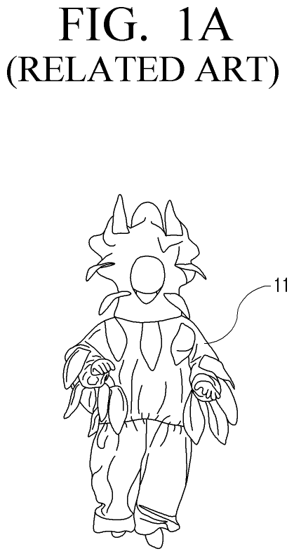

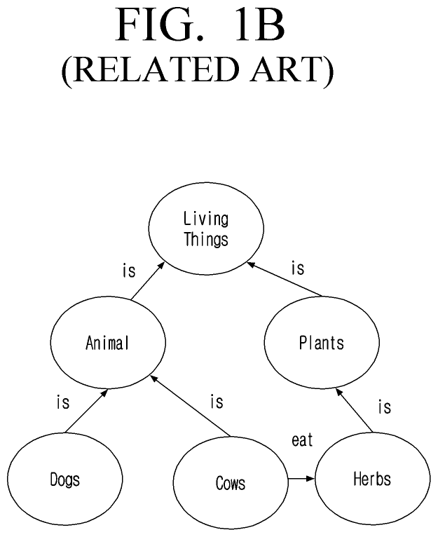

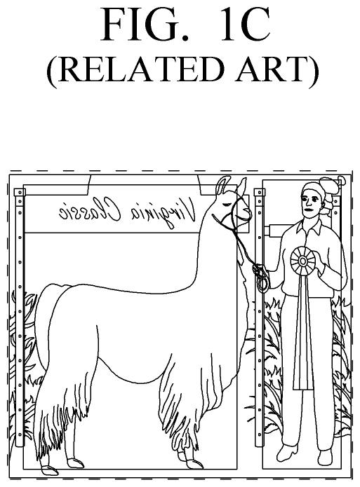

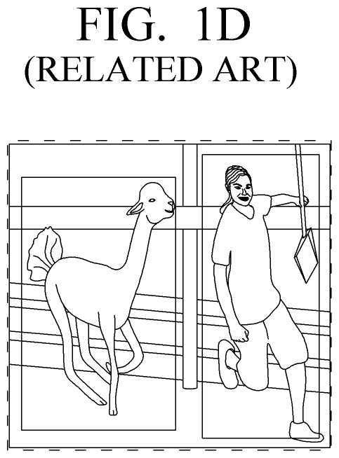

FIG. 1A is an example illustrating classification of objects, according to the related art.

Referring to FIG. 1A, conventional AI erroneously categorizes a human 1 as a tree, even when the human 1 is in motion. This is due to the limited capacity of conventional systems to comprehend visual abstractions. Regrettably, the AI model never assimilated the basic common-sense principle that trees do not possess the ability to walk.

FIG. 1B is a schematic diagram illustrating a knowledge graph, according to the related art.

Referring to FIG. 1B, the domain of knowledge graphs encompasses a vast array of factual and common sense information. Symbolic AI, usually measured in gigabytes (GBs), relies on these knowledge graphs to incorporate common sense. However, deploying these knowledge graphs on devices proves impossible for NSAI.

FIGS. 1C and 1D are examples illustrating linguistic concepts, according to the related art.

Referring to FIGS. 1C and 1D, conventional systems fail to understand linguistic concepts, for example, the conventional system fails to differentiate “standing next to” in FIG. 1C and “chasing” by an animal in FIG. 1D. This is because the conventional systems failed to understand the linguistic concepts. The conventional neural AI is also not able to differentiate the context in language because the AI model never learnt difference between “standing next to” and “chasing.”

The conventional AI methods do not improve the accuracy of AI without Common-sense Knowledge Graphs, and are incapable in explaining the predictions of the AI model without common-sense knowledge graphs. Moreover, the conventional techniques fail to preserve the precision of NSAI during the embedding or compression of common-sense knowledge graphs. Additionally, these methods lack the deployment of context and concept aware NSAI on both edge and mobile devices.

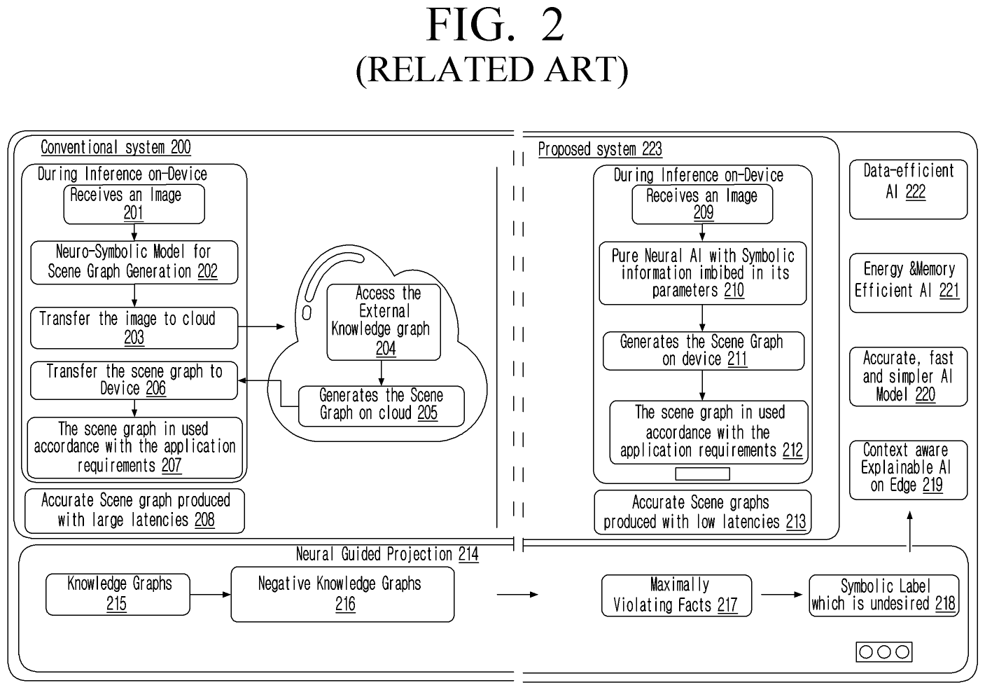

FIG. 2 is a schematic diagram illustrating a comparison of conventional systems, according to the related art.

Referring to FIG. 2, a conventional system 200 during inference on device receives an image, at 201. In 202, the neuro symbolic model is presented with the image to generate the scene graph. The image is transmitted to the cloud by the traditional system, at 203. At 204, the conventional system accesses the external knowledge graph. At 205, the customary system produces the scene graph via the external knowledge graph. At 206, the customary system acquires the scene graph from the cloud and transfers to the embedded device. Subsequently, at 207, the customary system operates the scene graph in accordance with the application requirements. At 208, the conventional system produces accurate scene graph and transfers to embedded devices with large latencies.

During inference on device, the proposed system 223 receives an image, at 209. At 210, This pure neural AI system incorporates symbolic information in its parameters. At 211, the resulting scene graph is then generated on device. Subsequently 212, the proposed system operates the scene graph in accordance with the application requirements. At 213, ultimately, the proposed system produces an accurate scene graph with minimal latencies.

Further, a neural guided projection 214 is described. At 215, the knowledge graph includes set of common-sense facts (for example, man wears suit is considered). At 216, a negative knowledge graph including complete violation of common sense is obtained (i.e. a set of illogical facts e.g. suit wears man is obtained). At 217, the maximally illogical facts (for example, man wearing woman) are generated. At 218, the system generates symbolic labels which are undesired and are used during training of the AI model.

The proposed method generates a context aware explainable AI on edge device 219. Moreover, it offers an AI model 220 that is both accurate and swift, yet uncomplicated. Additionally, it provides an energy and memory-efficient AI model 221 and a data-efficient AI model 222.

Typically, when compared to conventional neural AI, the technical impact of neural guided projection (NGP) is considerably more precise (for example, with an increase in accuracy of up to 30%). Additionally, the proposed system surpasses conventional NSAI methods in accuracy (for example, by 21%), when compared to a conventional NSAI methods, where the NSAI methods cannot be deployed on-device. Further, the proposed system even with reduction in data (e.g. 50% reduction in data), an accuracy drop in NGP is better than conventional neural AI (e.g. ˜3×times).

The proposed system offers a plethora of benefits, including enhanced accuracy, performance, and power efficiency, while also addressing issues such as memory latency. These advantages can be applied to various use cases in computer vision and natural language processing (NLP). For instance, the system enables advanced capabilities like gallery search, autonomous vehicles, robotics, and visual aid for the visually impaired. Such functionalities were previously unattainable with conventional neural AI models and other Symbolic approaches. Further, the incorporation of NSAI models on-device will not only elevate the user experience but also facilitate on-device learning and personalization, even in situations with limited data.

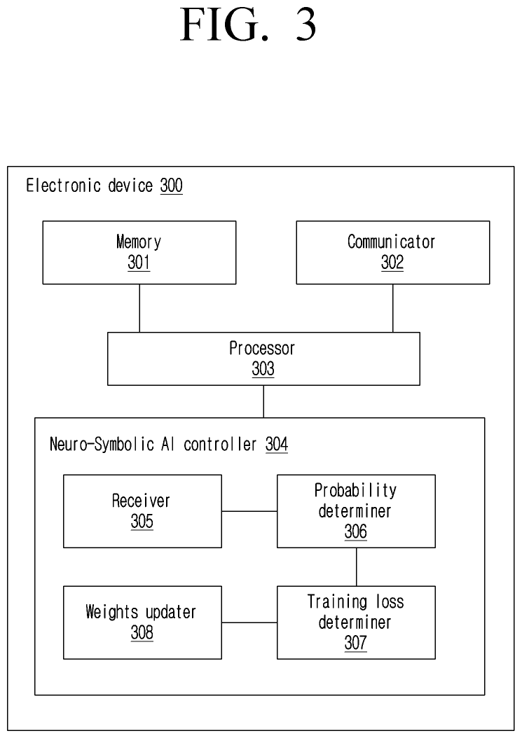

Referring now to the drawings, and more particularly to FIGS. 3 through 11, where similar reference characters denote corresponding features consistently throughout the figures, there are shown preferred embodiments.

FIG. 3 is a block diagram of an electronic device for training of an AI model, according to an embodiment of the disclosure.

Referring to FIG. 3, an electronic device 300 includes memory 301, a processor 303, a communicator 302, and a neuro-symbolic AI controller 304. The neuro-symbolic AI controller 304 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may for example, be embodied in one or more semiconductors.

The memory 301 stores instructions to be executed by the processor 303. The memory 301 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 301 may in some examples, be considered a non-transitory storage medium. The term “non-transitory” may indicate that the storage medium is not embodied in a carrier wave or a propagated signal. However, the term “non-transitory” should not be interpreted that the memory 301 is non-movable. In some examples, the memory 301 to stores larger amounts of information. In certain examples, a non-transitory storage medium may store data that can, over time, change (e.g., in Random Access Memory (RAM) or cache).

The processor 303 communicates with the memory 301, the communicator 302 and the neuro-symbolic AI controller 304. The processor 303 executes instructions stored in the memory 301 and to perform various processes. The processor 303 may include one or a plurality of processors, may be a general purpose processor, such as a central processing unit (CPU), an application processor (AP), or similar, as well as a graphics-only processing unit like a graphics processing unit (GPU), a visual processing unit (VPU), or an Artificial intelligence (AI) dedicated processor such as a neural processing unit (NPU).

The communicator 302 includes an electronic circuit specific to a standard that enables wired or wireless communication. The communicator 302 communicates internally between internal hardware components of the electronic device 300 and external devices through one or more networks.

In an embodiment, the neuro-symbolic AI controller 304 includes a receiver 305, a probability determiner 306, a training loss determiner 307, and a weights updater 308.

The receiver 305 receives input data including various a contents for training or learning an AI model. The probability determiner 306 determines a predicted probability for each of the contents of the input data in an output of the AI model. The training loss determiner 307 determines a neural loss the AI model through a comparison of predicted probabilities for each content against predetermined desired probabilities, while also assessing a symbolic loss by comparing predicted probabilities against predetermined undesired probabilities for each content. Further the training loss determiner 307 determines a training loss of the AI model as a measure of the neural loss and the symbolic loss. The training loss serves as an indicator of both the neural loss and symbolic loss. The weights updater 308 determines weights of multiple layers of the AI model and updates the weights of the one or more layers of the AI model in proportion to the determined training loss.

The neuro-symbolic AI controller 304 selects external symbolic knowledge graph including common-sense facts. Further, the neuro-symbolic AI controller 304 constructs a negative knowledge graph including violating common-sense facts from the external symbolic knowledge graph. Further, the neuro-symbolic AI controller 304 identifies a set of maximally violating facts from the violating common-sense facts. Further, the neuro-symbolic AI controller 304 generates symbolic labels for the maximally violating facts, wherein the maximally violating facts are undesired and wherein the symbolic labels are provided in terms of probabilities.

In an embodiment, the electronic device 300 receives knowledge graphs from users, which include personal user information. The electronic device 300 is then trained with these knowledge graphs to enhance its functionality.

In an embodiment, the AI model that has undergone training is implemented on either edge devices or servers. The input data in the embodiments encompasses various forms, such as, but not limited to, images, audio, video, and text.

In an embodiment, the common-sense facts includes a set of pre-defined rules and common-sense facts associated with a real-world.

In an embodiment, the maximally violating facts includes facts which are against the common-sense facts with respect to the input data.

The neuro-symbolic AI controller 304 determines the various contents and relationships between the various contents. Further, the neuro-symbolic AI controller 304 determines a scene graph based on the determined contents and relationships between the contents. The scene graph is a structural representation of various contents and the relationships between the contents in the input data.

It is to be noted that identification of the content is performed by a neural AI, while discernment of relationships between such content is carried out by a symbolic AI that adheres to common-sense principles of the real world. This is accomplished through the use of an external symbolic knowledge graph.

It is possible for the neuro-symbolic AI controller 304 to employ an AI model to execute at least one of the various modules/components available. A function associated with the AI model may be performed through memory 301 and the processor 303. A singular or multiple processors oversee the processing of input data, adhering to a predetermined operational protocol or AI model that is retained in both non-volatile and volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

While FIG. 3 depicts a range of hardware components found in the electronic device 300, it should be noted that alternative embodiments are not constrained to this configuration. The number of components included in the electronic device 300 may vary in other embodiments. Moreover, the labels or names assigned to each component are intended for illustrative purposes only and do not restrict the scope of the disclosure. It is possible for two or more components to be merged to serve the same or nearly identical function in the electronic device 300.

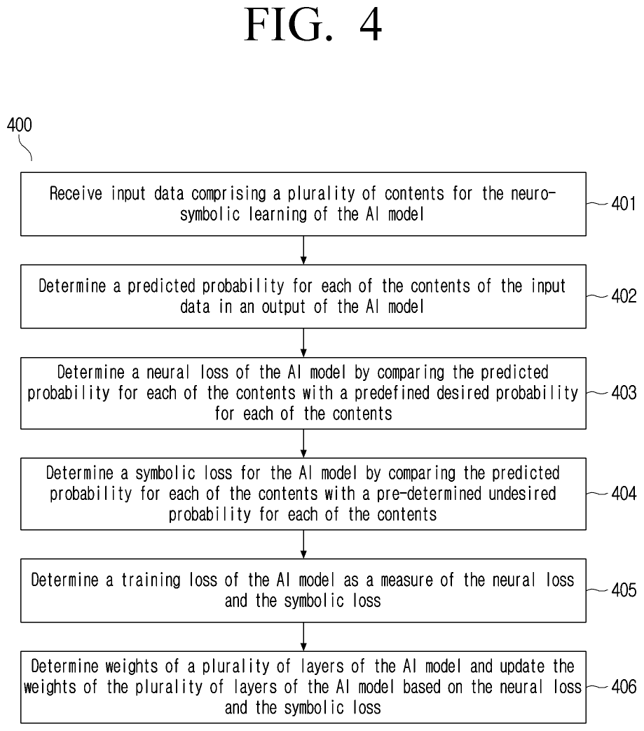

FIG. 4 is a flowchart illustrating a method for training of the AI model, according to an embodiment of the disclosure.

Referring to FIG. 4, flowchart 400 illustrates that, at operation 401, the electronic device 300 receives input data including various contents for neuro-symbolic learning or training the AI model. For example, in the electronic device 300 described in the FIG. 4, the neuro-symbolic AI controller 304 receives the input image including the plurality of objects for neuro-symbolic learning or training the AI model.

At operation 402, the electronic device 300 determines the predicted probability for each of the contents of the input data in the output of the AI model. In the electronic device 300 depicted in FIG. 4, the neuro-symbolic AI controller 304 ascertains the anticipated likelihood for each content of the input image(s) within the AI model's output.

At operation 403, the electronic device 300 determines the neural loss of the AI model by comparing the predicted probability for each of the contents with the predefined desired probability for each of the contents. For example, the neuro-symbolic AI controller 304 determines the neural loss of the AI model based on a comparison of the predicted probability for each of the contents of the input image with the predefined probability for each of the contents.

At operation 404, the electronic device 300 determines the symbolic loss for the AI model by comparing the predicted probability for each of the contents with the pre-determined undesired probability for each of the contents. For example, in the electronic device 300 described in the FIG. 4, the neuro-symbolic AI controller 304 is equipped to determine the symbolic loss for the AI model based on a comparison of the predicted probability for each content of the input image with the pre-determined undesired probability for each content.

At operation 405, the electronic device 300 determines the training loss of the AI model as the measure of the neural loss and the symbolic loss. In one embodiment, the training loss is established by the application of various functions, such as addition, subtraction, multiplication, and division, on both the neural loss and the symbolic loss.

At operation 406, the electronic device 300 determines weights of the one or more layers of the AI model and update the weights of the one or more layers of the AI model in proportion to the determined training loss. For example, in the electronic device 300 described in FIG. 3, the neuro-symbolic AI controller 304 determines the weights of the one or more layers of the AI model in proportion to the determined training loss.

The various actions, acts, blocks, operations, or the like in the flowchart 400 may be performed in the order presented, in a different order or simultaneously. Further, in some embodiments, some of the actions, acts, blocks, operations, or the like may be omitted, added, modified, skipped, or the like without departing from the scope of the disclosure.

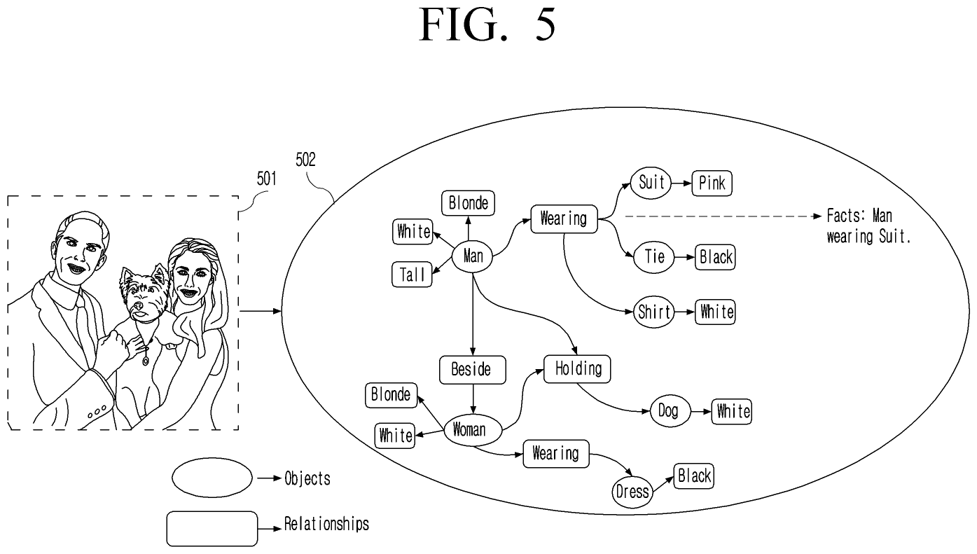

FIG. 5 is an example illustrating a scene graph generation for understanding visual concepts, according to an embodiment of the disclosure.

Referring to FIG. 5, the generation of a scene graph serves the purpose of comprehending visual concepts. In this context, the proposed methodology strives to construct structural representations of diverse elements in an image 501, through the creation of scene graphs 502. This is achieved by tasking the AI model with the detection of all objects present in the image, as well as the identification of the relationships that exist between the objects.

In an embodiment, the object detection is possible with neural AI, and the relationship detection is possible with symbolic AI.

Referring to FIG. 5, the ‘Man wearing Suit’ can be extracted as a fact from the scene graph. Similarly, ‘man beside a woman holding dog’ is another fact for building the scene graphs 502.

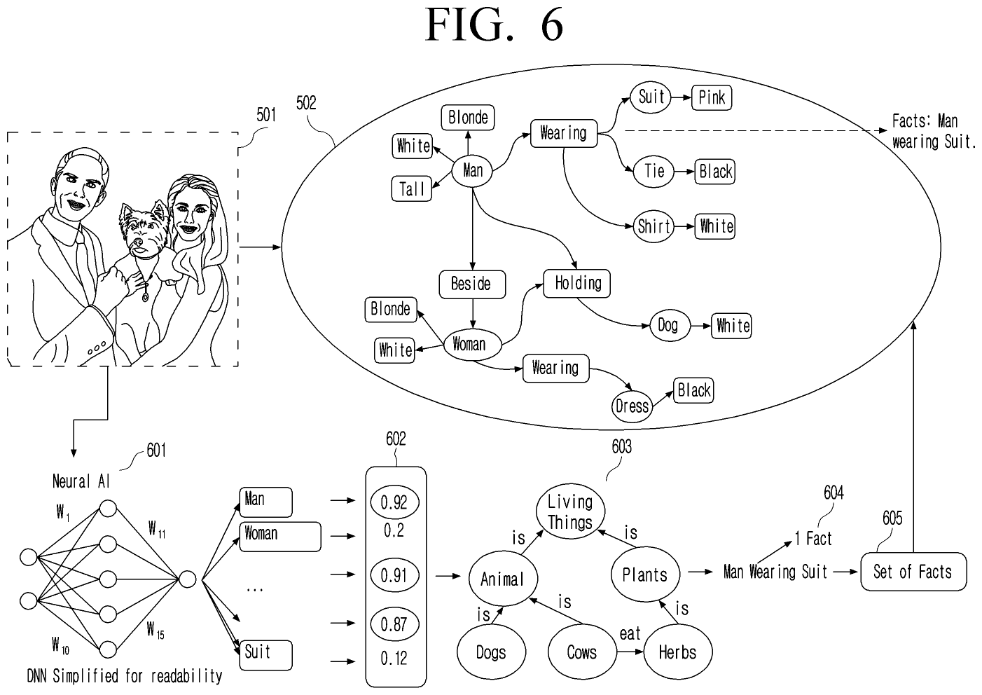

FIG. 6 is an example illustrating the scene graph generation through a neuro-symbolic AI controller, according to an embodiment of the disclosure.

Referring to FIG. 6, at operation 601, an image 501 is provided to the neural AI. The DNN is simplified for readability in the image. At operation 602, the neuro-symbolic AI controller 304 assigns the probabilities for the prediction of the objects. At operation 603, the symbolic AI determines the relationships between the objects detected by the neural AI of the neuro-symbolic AI controller 304.

In the subsequent operation 604, facts are ascertained from the symbolic AI, while in operation 605, the set of facts are derived from the same AI system to generate the scene graph. The conventional neuro-symbolic training pipeline is indicated in FIG. 6. However, the difficulty lies in the requirement of the symbolic AI in both the training and inference pipelines, rendering its on-device deployment unfeasible.

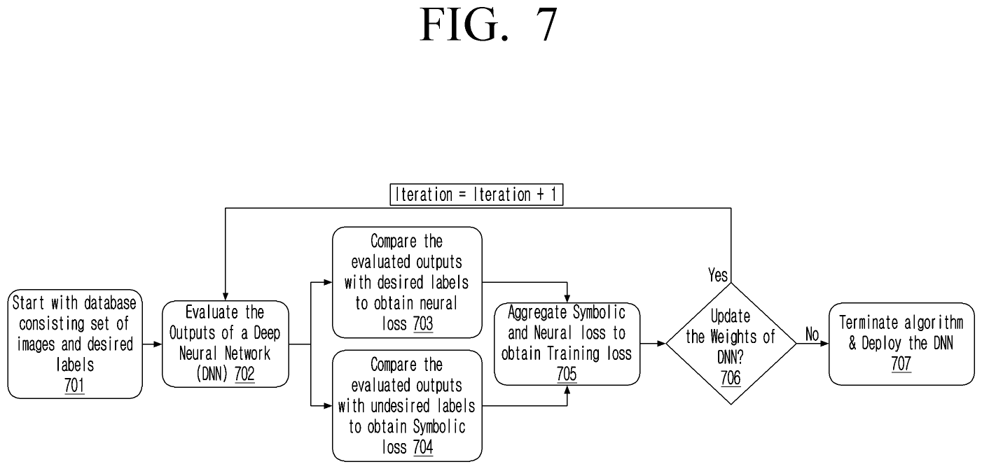

FIG. 7 is a flowchart illustrating the proposed method for providing neuro-symbolic AI on an embedded device, according to an embodiment of the disclosure.

Referring to FIG. 7, at the onset of operation 701, commence the initial iteration by employing a database including a collection of images and their corresponding labels of interest. Moving on to operation 702, proceed to evaluate the outputs of a deep neural network (DNN). Gradually advancing to operation 703, make a comparative analysis between the evaluated outputs and the desired labels, thereby deriving the neural loss.

At operation 704, the system compares the evaluated outputs with undesirable labels to obtain the symbolic loss, which is then aggregated with the neural loss to obtain the training loss, at operation 705. The challenges in generating the undesired labels are resolved using the neural guided projection of the proposed system to provide the following advantages:
Knowledge graphs are not required during training.
Enables faster training.
Enables on-device learning.
Incorporates the symbolic knowledge graph.
Additional loss value regulates the DNN.
Symbolic loss minimizes DNN complexity.
Simpler DNN ensures better performance

At operation 706, the system determines whether an update to the weights of the DNN is required. If so, the next iteration begins. Otherwise, the proposed system terminates the process and deploys the DNN, at operation 707. The challenges in deployment of the DNN to eliminate the need of symbolic knowledge graph are resolved by a deployment pipeline to provide the following advantages:
No need for Knowledge graphs during on-device inference.
Enables faster inference.
Enhances user experience.
Explainable and Accurate Results.
Reduced memory usage and latency.

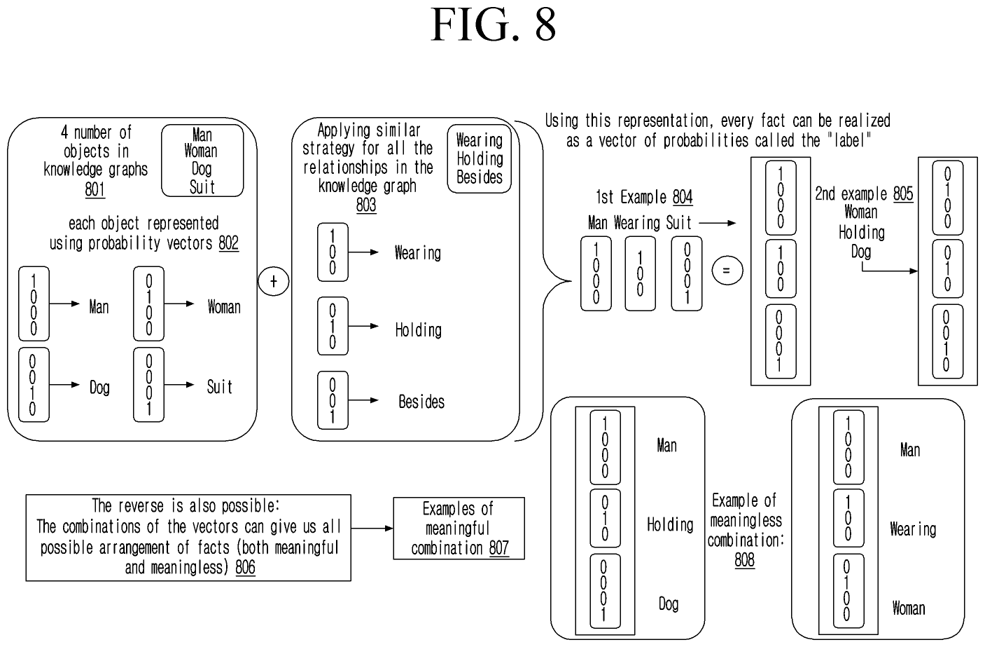

FIG. 8 is a schematic diagram illustrating converting the symbolic AI into labels, according to an embodiment of the disclosures.

Referring to FIG. 8, at operation 801, let us consider the presence of four objects in knowledge graphs, namely, man, woman, dog, and suit. Moreover, at operation 803, a similar approach should be adopted for all the relationships present in the knowledge graph, namely, Wearing, Holding, and Besides. At operation 803, three relationships are adopted as a 3 element vector where all are zeros except the one location which corresponds to one relationship.

Using this representation, each fact may be represented as a probability vector 802, denoted as the label. These labels for the facts are obtained by combining the labels various labels, such as the Woman Holding Dog 805 and the Man Wearing Suit 804. Conversely, at operation 806, it is also possible to break down the vectors to obtain all feasible arrangements of facts, whether sensible or nonsensical. At operation 807, as illustrations of meaningful combinations, the Man Holding Dog is provided. At operation 808, the example of meaningless combination Man Wearing Woman is provided.

Referring to FIG. 8, the symbolic knowledge graphs can be converted into vectors of probabilities called labels. It is also realized that a combination of vectors can lead to both meaningful facts and meaningless facts. Therefore, starting with the symbolic knowledge graphs, a large collection of meaningless facts can be prepared.

Consider the instance of the FIG. 8, where four objects interact through three relationships, leading to a grand total of 64 facts, some of which hold significance while others do not. Subsequently, after extracting the meaningful facts present in the knowledge graphs, the remaining set of facts that contradict common sense are identified as integrity constraints. These constraints are indicative of the combinations that are not linked in the knowledge graphs.

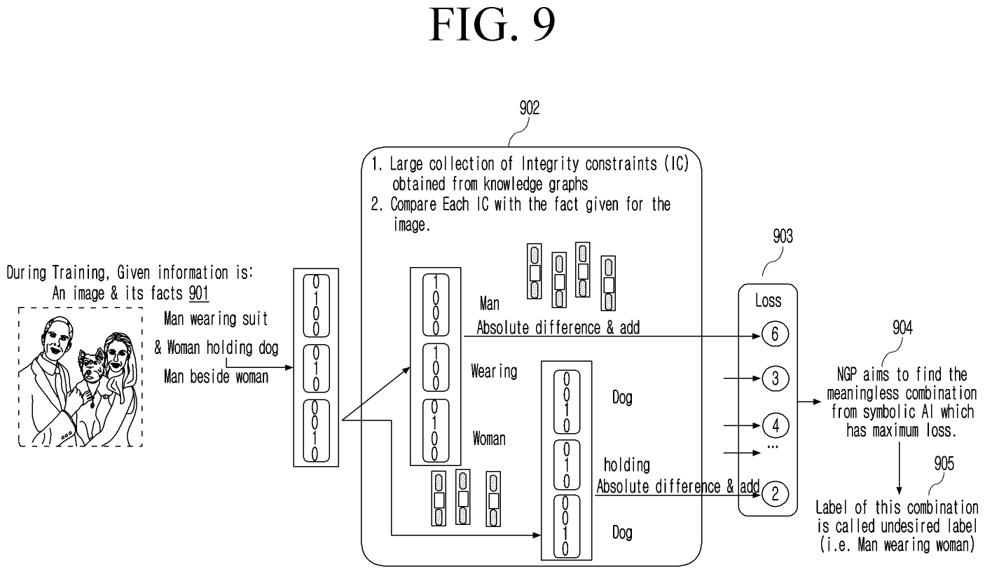

FIG. 9 is a schematic diagram illustrates obtainment of undesired label, according to an embodiment of the disclosure.

Referring to FIG. 9, in an embodiment, at operation 901, the requirement is to predict the facts in the image and not all possible valid facts. For example, “Man holding shirt” is a valid fact but it is not present in the image and hence, the AI need not predict it. To address the issues in the proposed method, during training, given information includes the image and its facts. The desired facts including all the valid and meaningful facts that is included in the given dataset. So “Man holding shirt” is not be included here. The desired facts are “Man wearing suit,” “Woman holding dog,” and “Man beside woman.” So “Man holding shirt” is not included as the desired label. Thus, the AI will not predict “Man holding shirt.” Through the NGP, the undesired facts are created as described in the FIG. 9 which are always invalid or meaningless. So, the AI model also does not predict these meaningless facts.

At operation 902, the proposed electronic device 300 analyzes a plethora of integrity constraints (IC) derived from knowledge graphs, comparing each IC with the provided image fact. Moving on to operation 903, the electronic device 300 then calculates the loss (such as absolute difference and addition) for every IC utilizing the knowledge graph. Out of all the possible combinations, the electronic device 300 selects the one with the maximum loss, consisting of parts that are not connected in the image and the knowledge graph. An example of such a combination is a man wearing women's clothing. At operation 904, the electronic device 300 endeavors to identify the meaningless combination from symbolic AI with the highest loss. Finally, at operation 905, the electronic device 300 labels the combination as an undesired label (i.e., man wearing women's clothing).

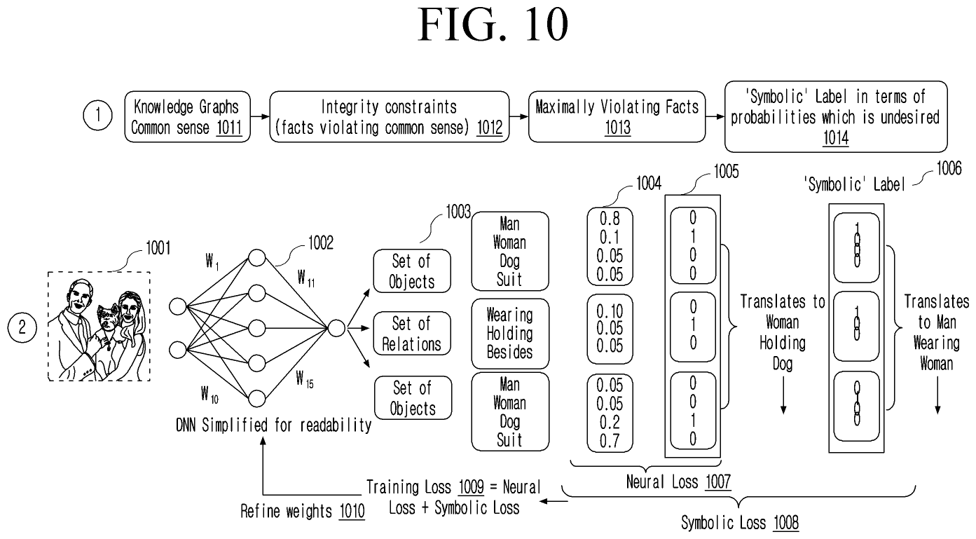

FIG. 10 is a schematic diagram illustrating training pipeline of a neuro-symbolic AI controller, according to an embodiment of the disclosure.

Referring to the FIG. 10, at phase 1, at operation 1011, the Symbolic AI knowledge graphs based on the common sense are converted into symbolic labels. Set of common-sense facts can be, for example, Man wears Suit.

At operation 1012, integrity constraints (facts violating common sense) or set of negative common-sense facts are identified. For example, Suit wears Man. At operation 1013, maximally violating facts are determined for example, Man Wearing Woman. At operation 1014, the ‘symbolic’ label in terms of probabilities which is undesired is determined.

At phase 2, the training data with the image and the desired label is used initially. At operation 1003, the various objects in an image 1001 and the relationships are determined using DNN 1002. At operation 1004 and operation 1005, the predicted probabilities are determined and a neural loss 1007 is calculated based on the difference between the predicted probabilities and the desired probabilities. At operation 1006, the proposed system determines the symbolic labels based on the undesired probabilities and determine a symbolic loss 1008 for the AI model by comparing the predicted probability for each of the contents with the undesired probability for each of the contents. Further, the symbolic loss 1008 is projected on to a training loss 1009, where the training loss 1009 of the AI model is the measure of the neural loss 1007 and the symbolic loss 1008. Further, at operation 1010, the proposed system determines weights of the multiple layers of the AI model and updates the weights of the one or more layers of the AI model in proportion to the determined training loss 1009.

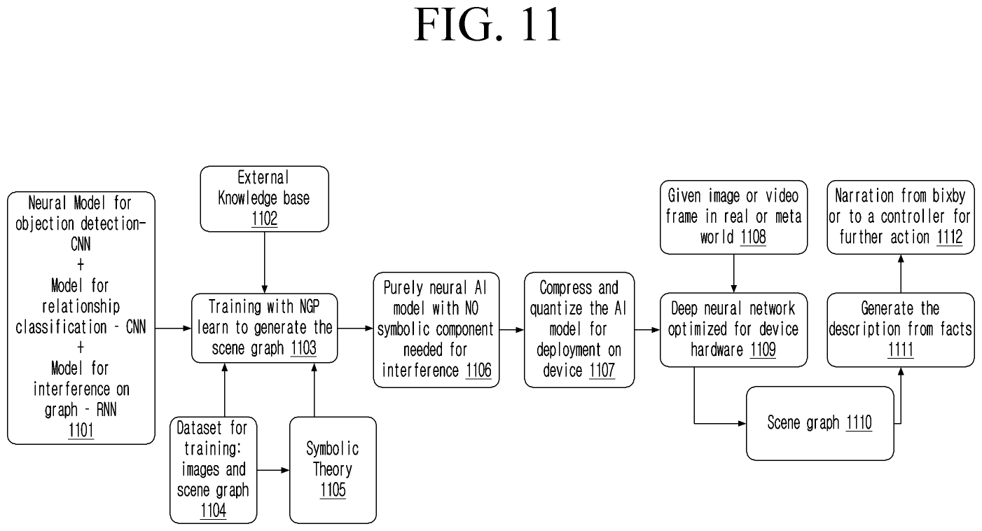

FIG. 11 is a flowchart illustrating the deployment pipeline, according to an embodiment of the disclosure.

Referring to FIG. 11, at operation 1101, a model is created through the merging of a neural model for objection detection, a CNN model for relationship classification, and a model for interference on graph RNN.

Moving on to operation 1103, the proposed system is trained using NGP learn. This process involves generating the scene graph and utilizes external knowledge base 1102, a dataset consisting of training images and scene graphs 1104, as well as a symbolic theory 1105.

Operation 1106 sees the proposed system utilizing a purely neural AI model, sans any requirement for symbolic components in interference.

At operation 1107, the AI model is compressed and quantized, thereby making it deployable on the device.

In operation 1109, the deep neural network is optimized for device hardware, taking into consideration a given image or video frame in the real or meta world 1108.

Operation 1110 sees the scene graph being generated, with the proposed system generating descriptions from facts, at operation 1111, based on the scene graph.

Finally, operation 1112 involves the proposed system narrating through Bixby or a controller, leading to further action.

The various actions, acts, blocks, operations, or the like in the flow diagram may be performed in the order presented, in a different order or simultaneously. Further, in some embodiments, some of the actions, acts, blocks, operations, or the like may be omitted, added, modified, skipped, or the like without departing from the scope of the disclosure.

The proposed method and electronic device 300 have the following advantages:

Privacy: Knowledge graphs are not only personalized but also secure, and the parameters of the AI are fine-tuned that does not reveal the identity of the user.

Personalize: The proposed method and electronic device 300 are trained with knowledge graphs that emulate common-sense. The knowledge graph is personalized, allowing for effortless fine-tuning of the NSAI to cater to the specific needs of the user.

On the fly: The proposed method and electronic device 300 does not necessitate storing the descriptive facts generated. This allows scale up of NGP based NSAI for multi-functional usage.

Explainable AI: The proposed method and electronic device 300 allows the AI with the capacity to grasp abstract ideas and explicate behaviors in a manner akin to that of humans.

Accuracy: The disclosure introduces a novel technique and electronic device 300 that enhances the precision of conventional AI without any additional overhead.

Speed: The method and electronic device 300 have been devised to translate into a deep neural network that has been meticulously optimized for swift performance on hardware.

Lightweight: The proposed method and electronic device 300 eliminates the need for knowledge graphs during interference and thereby reducing the memory footprint.

While the disclosure has been shown and described with reference to various embodiments therefore, it will be understood by those skilled in the art that various changes in form and details may be made therein without departing from the spirit and scope of the disclosure as defined by the appended claims and their equivalents.

What is claimed is:

1. A method for neuro-symbolic learning of an artificial intelligence (AI) model, the method comprising:
receiving, by an electronic device, input data comprising a plurality of contents for the neuro-symbolic learning of the AI model;
determining, by the electronic device, a predicted probability for each of the plurality of contents of the input data in an output of the AI model;
determining, by the electronic device, a neural loss of the AI model by comparing the predicted probability for each of the plurality of contents with a predefined desired probability for each of the plurality of contents;
determining, by the electronic device, a symbolic loss for the AI model by comparing the predicted probability for each of the plurality of contents with a pre-determined undesired probability for each of the plurality of contents;
determining, by the electronic device, weights of a plurality of layers of the AI model; and
updating, by the electronic device, the weights of the plurality of layers of the AI model based on the neural loss and the symbolic loss.

2. The method of claim 1, wherein the updating, by the electronic device, the weights of the plurality of layers of the AI model based on the neural loss and the symbolic loss comprises:
determining, by the electronic device, a training loss of the AI model as a measure of the neural loss and the symbolic loss; and
updating, by the electronic device, the weights of the plurality of layers of the AI model in proportion to the determined training loss.

3. The method of claim 1,
wherein the pre-determined undesired probability for each of the plurality of contents in the input data is determined by the electronic device,
wherein the determining of the pre-determined undesired probability for each of the plurality of contents comprises:
selecting, by the electronic device, an external symbolic knowledge graph comprising a plurality of common-sense facts;
constructing, by the electronic device, a negative knowledge graph comprising a plurality of violating common-sense facts from the external symbolic knowledge graph;
identifying, by the electronic device, a set of maximally violating facts from the plurality of violating common-sense facts; and
generating, by the electronic device, symbolic labels in a form of probabilities for the maximally violating facts, and
wherein the maximally violating facts comprise the undesired probability.

4. The method of claim 3, wherein the plurality of common-sense facts comprise at least one of a set of pre-defined rules or common-sense facts associated with a real-world.

5. The method of claim 3, wherein the maximally violating facts further comprise facts which are against the plurality of common-sense facts with respect to the input data.

6. The method of claim 1, further comprising:
determining, by the electronic device, the plurality of contents and relationships between the plurality of contents; and
determining, by the electronic device, at least one scene graph based on the plurality of contents and the relationships between the plurality of contents,
wherein the at least one scene graph comprises a structural representation of the plurality of contents and the relationships between the plurality of contents in the input data.

7. The method of claim 6, wherein the plurality of contents is determined using neural AI and the relationships between the plurality of contents is determined using symbolic AI, adhering to common-sense of a real world through an external symbolic knowledge graph.

8. An electronic device for neuro-symbolic learning of an artificial intelligence (AI) model, the electronic device comprising:
a processor;
a communicator;
a neuro-symbolic AI controller; and
memory storing one or more programs including computer-executable instructions that, when executed by the processor, cause the electronic device to:
receive input data comprising a plurality of contents for the neuro-symbolic learning of the AI model,
determine a predicted probability for each of the plurality of contents of the input data in an output of the AI model,
determine a neural loss of the AI model by comparing the predicted probability for each of the plurality of contents with a predefined desired probability for each of the contents,
determine a symbolic loss for the AI model by comparing the predicted probability for each of the plurality of contents with a pre-determined undesired probability for each of the contents,
determine a training loss of the AI model as a measure of the neural loss and the symbolic loss,
determine weights of a plurality of layers of the AI model, and
update the weights of the plurality of layers of the AI model based on the neural loss and the symbolic loss.

9. The electronic device of claim 8, wherein the one or more programs further include instructions that, when executed by the processor, cause the electronic device to:
determine a training loss of the AI model as a measure of the neural loss and the symbolic loss, and
update the weights of the plurality of layers of the AI model in proportion to the determined training loss.

10. The electronic device of claim 8,
wherein the one or more programs further include instructions that, when executed by the processor, cause the electronic device to:
select an external symbolic knowledge graph comprising a plurality of common-sense facts,
construct a negative knowledge graph comprising a plurality of violating common-sense facts from the external symbolic knowledge graph,
identify a set of maximally violating facts from the plurality of violating common-sense facts, and
generate symbolic labels for the maximally violating facts,
wherein the maximally violating facts are undesired, and
wherein the symbolic labels are provided in terms of probabilities.

11. The electronic device of claim 10, wherein the plurality of common-sense facts comprise at least one of a set of pre-defined rules or common-sense facts associated with a real-world.

12. The electronic device of claim 10, wherein the maximally violating facts comprise facts which are against the plurality of common-sense facts with respect to the input data.

13. The electronic device of claim 8,
wherein the one or more programs further include instructions that, when executed by the processor, cause the electronic device to:
determine the plurality of contents and relationships between the plurality of contents, and
determine at least one scene graph based on the determined plurality of contents and relationships between the plurality of contents, and
wherein the at least one scene graph comprises a structural representation of the plurality of contents and the relationships between the plurality of contents in the input data.

14. The electronic device of claim 13, wherein the plurality of contents is determined using a neural AI and the relationships between the plurality of contents is determined using a symbolic AI, adhering to common-sense of a real world through an external symbolic knowledge graph.

15. The electronic device of claim 8,
wherein the training loss is determined by applying various functions on both the neural loss and the symbolic loss, and
wherein the various functions include addition, subtraction, multiplication, and division.

16. One or more non-transitory computer-readable storage media storing one or more computer programs including computer-executable instructions that, when executed by one or more processors of an electronic device, cause the electronic device to perform operations, the operations comprising:
receiving input data comprising a plurality of contents for neuro-symbolic learning of an artificial intelligence (AI) model;
determining a predicted probability for each of the plurality of contents of the input data in an output of the AI model;
determining a neural loss of the AI model by comparing the predicted probability for each of the plurality of contents with a predefined desired probability for each of the plurality of contents;
determining a symbolic loss for the AI model by comparing the predicted probability for each of the plurality of contents with a pre-determined undesired probability for each of the plurality of contents;
determining weights of a plurality of layers of the AI model; and
updating the weights of the plurality of layers of the AI model based on the neural loss and the symbolic loss.

17. The one or more non-transitory computer-readable storage media of claim 16, the operations further comprising:
determining a training loss of the AI model as a measure of the neural loss and the symbolic loss; and
updating the weights of the plurality of layers of the AI model in proportion to the determined training loss.

18. The one or more non-transitory computer-readable storage media of claim 16, the operations further comprising:
selecting an external symbolic knowledge graph comprising a plurality of common-sense facts;
constructing a negative knowledge graph comprising a plurality of violating common-sense facts from the external symbolic knowledge graph;
identifying a set of maximally violating facts from the plurality of violating common-sense facts; and
generating, by the electronic device, symbolic labels in a form of probabilities for the maximally violating facts,
wherein the maximally violating facts comprise the undesired probability.

19. The one or more non-transitory computer-readable storage media of claim 18, wherein the plurality of common-sense facts comprise at least one of a set of pre-defined rules or common-sense facts associated with a real-world.

20. The one or more non-transitory computer-readable storage media of claim 16, the operations further comprising:
determining the plurality of contents and relationships between the plurality of contents; and
determining at least one scene graph based on the plurality of contents and the relationships between the plurality of contents,
wherein the at least one scene graph comprises a structural representation of the plurality of contents and the relationships between the plurality of contents in the input data.
